(19) United States
(12) Patent Application Publication
(10) Pub. No.: US 2013/0104403 A1
(43) Pub. Date: May 2, 2013

(54) Knife and Handle for Knife

(71) Applicant: Brendan Stokes, Flemington, NJ (US)

(72) Inventor: Brendan Stokes, Flemington, NJ (US)

(21) Appl. No.: 13/661,093

(22) Filed: Oct. 26, 2012

Related U.S. Application Data
(60) Provisional application No. 61/551,711, filed on Oct. 26, 2011.

(51) Int. Cl. B26B 3/00; B25G 3/32

(52) U.S. Cl. 30/165; 30/342

(57) ABSTRACT

A knife with a handle attached to the blade is described. The handle extends horizontally down the spine towards the tip and vertically down the heel to cover a portion of the blade. The inventive knife is particularly suited for use when choking up. The handle of the knife extends beyond the bolster, or where the bolster would typically be on a knife, and covers a portion of the spine and heel of the knife. The shape and positioning of the handle provides a useful, comfortable handle surface for the forefinger, thumb and palm when choking up on the knife. In contrast to prior art knives, the present invention provides a protection to the user's hand which is integral with the handle of the knife therefore prevents any protective elements from slipping out of place during use.

### RELATED APPLICATIONS

This application claims priority to provisional application No. 61/551,711 filed Oct. 26, 2011, the contents of which is incorporated by reference in its entirety.

### BACKGROUND OF THE INVENTION

1. Field of the Invention

The present invention relates to knives. More specifically the present invention is related to handles for knives.

2. Description of Related Art

With traditional knives, the handle stops abruptly at the bolster. Users of knives, and in particular chefs, will often be required to “choke up” on the knife. Choking up on the knife refers to gripping the knife so that their palm is placed forward blade while the ring finger, middle finger, and outermost finger curl under the handle. In some instances, users will choke up on the knife to the extent that the part of the palm between the thumb and forefinger is pressing on the spine of the blade.

While giving extra control over certain cutting actions, choking up can be uncomfortable and possibly hazardous to the user. For example, the portion of the palm and/or forefinger which rests on the top edge of the knife blade can become raw and eventually develop blisters and callouses after repeated use. The pressure increases at the abrupt ninety-degree corners where the horizontal surface of the top edge of the knife blade meets the sides of the knife blade. Second, in the choking up position, the edge of the heel of the knife blade typically rests against a portion of the middle finger. After repeated use, this portion of the middle finger is also subjected to a great deal of pressure by the narrow edge of the heel section of the blade. Third, the section of the palm and three fingers which remain in control of the handle section of the knife are also subjected to pressure due to the grip required in choking up on the knife. Fourth, when using a knife in the choking up position, the surface of the blade can be slippery and cause the user to lose control of the knife and possibly lead the user to cut his own hand.

Given these shortcomings associated with the choking up position, it would be desirable to have a knife or knife handle that allowed the user to choke up and not have to directly grip the spine and/or heel and/or handle of the knife. It would be desirable to have a knife that provided improved comfort for the user and control over the knife when the user is choking up during cutting.

Prior art knives focus on overcoming the problem associated with pressure from the top edge of the knife blade on the palm or forefinger. For example, U.S. Pat. No. 7,434,320 discloses a blade grip for the top edge of a knife blade which allows the user to place his thumb and portion of forefinger on prefabricated indentations of the blade grip. However, the U.S. Pat. No. 7,434,320 blade grip is installed onto the top edge of a knife blade and thus has a tendency to slip off the blade, or up the blade of the knife, after rough use and/or repeated use. If installed using adhesive, the adhesive may break down due to the conditions in a kitchen, such as the foods, temperatures and even soaps a knife will typically be exposed to. Furthermore, the U.S. Pat. No. 7,434,320 design does not take into account the pressure exerted on other parts of the hand, such as the pressure from the heel of the blade on a portion of the middle finger, and the pressure on a section of the palm and three fingers which grip the handle section of the knife. Finally, the design of U.S. Pat. No. 7,434,320 may allow food to get trapped between the space between the handle and the grip and the handle, which can result in an unsanitary, difficult to clean kitchen knife.

### SUMMARY OF THE INVENTION

The present invention provides a knife handle and knife, particularly suited for use when choking up. The handle of the knife extends beyond the bolster, or where the bolster would typically be on a knife, and covers a portion of the spine and heel of the knife. The shape and positioning of the handle provides a useful, comfortable handle surface for the forefinger, thumb and palm when choking up on the knife. In contrast to prior art knives, the present invention provides a protection to the user's hand which is integral with the handle of the knife therefore prevents any protective elements from slipping out of place during use.

Preferably the portion of the handle that extends beyond the bolster (or again where the bolster would typically be) onto the spine and heel is integral with the rest of the knife handle. However, this portion may be a separate component of the handle. In one embodiment the handle is made from a completely transparent soft silicone. This material provides a handle that is slightly softer than the typical silicone handle. The softer handle providing more comfort and control for the user, especially in the choked up position, but still maintaining control and durability. The silicone handle covers what would traditionally be the bolster and proceeds up the spine to provide comfort when the user is choking up on knife. In knives with a bolster, the handle covers the bolster as it extends over the back portion of the blade. The exact length that the extended handle extends up the spine will vary according to the style of knife and how much the user may intend to choke up.

Optionally, the knife handle includes symmetrical grooves on either side of handle extension to accommodate both left and right handed users. The grooves function to direct the user's fingertip back towards the user to improve comfort and control.

The knife of the present invention has many advantages over the prior art knives. Some advantages include the following. The handle of the knife directs the finger away from the blade edge and encourages user to hold knife correctly. The handle of the knife also provides better and more comfortable use when holding/using conventional method. When compared to prior art knives, the inventive knife minimizes or eliminates the risk of the portion of the handle that extends beyond the bolster from slipping or moving when being used. In addition, the heel is incorporated into the handle at an angle to force the food/liquid from food to naturally flow away from blade. This is important as sometimes the food can contact the user's fingers and then end up in the food when choking up on a conventional knife or using prior art knives such as that disclosed in U.S. Pat. No. 7,434,320.

Other aspects of the invention will be apparent to those of ordinary skill in the art in view of the disclosure provided herein.

### BRIEF DESCRIPTION OF THE DRAWINGS

For a better understanding of the present invention, reference may be made to the accompanying drawings. The following drawings are for illustrative purposes only and are not intended to limit the scope of the present invention in any way:

FIG. 1 represents a side view of one embodiment of the knife of the present invention.

FIG. 2 represents a close up view of one embodiment of the handle of the knife of the present invention.

FIG. 3 represents the top view of one embodiment of the handle of the knife of the present invention.

### DETAILED DESCRIPTION

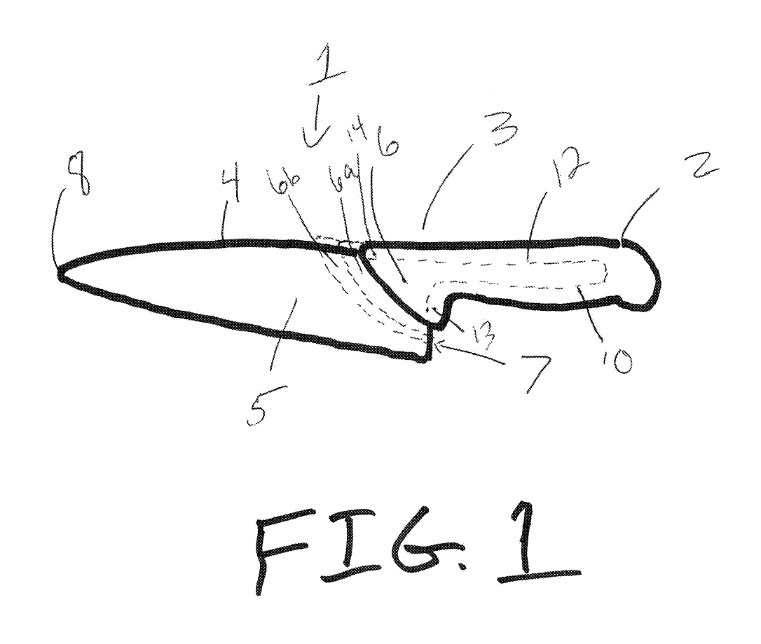

One embodiment of the knife of the current invention is illustrated in FIG. 1. In FIG. 1, the knife 1 and handle 2 are not particularly drawn to scale. That is, the dimensions of the knife 1 and the dimensions of the handle 2, both independently and in relation to each other can be different. The important aspect is that the handle 2 extends over the bolster, or what would be the bolster 3, onto the spine 4 of the blade 5 and covering a portion 6 of the heel 7 closest to the handle 2. The actual dimensions of the portion 6 over the blade 5 is not critical so long as it provides enough surface area to allow the user to choke up on the blade 5 and still be gripping the handle 2 with the thumb and forefinger. For example, in one embodiment, the handle extends about 40 mm past the bolster towards the tip 8. However, this amount can be greater or less depending on the size of the blade, the intended use, and other factors. In one embodiment, the handle extends about 35 mm down the heel of the blade but again can be more or less. Numerals 6a and 6b, represented by dotted lines show different embodiments of the size of the portion over the blade. As indicated the shape and size can be different from the embodiments shown.

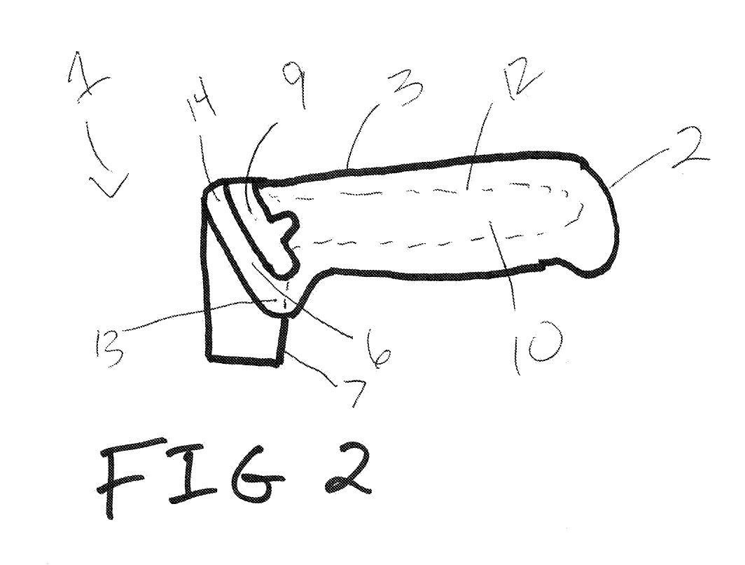

As shown in FIGS. 1 and 2, the handle 5 has a gripping portion 12. The portion 6 of the handle has a heel covering portion 13 which covers all or part of the heel 7, and spine covering portion 14 which covers all or preferably part of the spine 4 and extends one each side to cover a portion of one or both sides of the blade 5. In use, the user may place his thumb on portion 6 and his forefinger on the portion 6 on the reverse side of the spine covering portion 14 of the handle, while also wrapping his middle finger, ring finger and outermost finger around the gripping portion 12 of the handle. While these parts of the handle 5 have been described as separate parts, they are preferably different areas a handle of unitary construction.

In operation, as the user grips the handle 2 in this manner, the material of the handle is such that the hard surfaces of the spine, heel and handle are cushioned to protect the user from any discomfort and/or pressure. For example, as the user presses down on the knife handle, his forefinger and a portion of his palm are pushed down against the spine covering portion 14 of the handle instead of the spine on its own. Furthermore, as the user slides the knife in a horizontal manner, his middle finger will press up against the heel covering portion 13 of the handle, thus relieving the user of direct contact between the heel and the user's middle finger. The soft cushion material of the gripping portion 12 of the handle similarly relieves the user of the pressure on his palm and middle finger, ring finger and outermost finger which results from gripping the handle.

The handle of the present invention provides an ergonomic hold and great versatility to the user, who may wish to vary the grip of his knife or change the position of his fingers in order to achieve a desired type of cut. The present invention allows for such versatility by providing a handle which may be comfortably used in various positions and manipulated by the user in various ways without sacrificing the safety of the user.

In one embodiment, the handle has one or more recesses which accommodate the user's fingers and thus provide further comfort to the user. The handle may also contain one or more grooves or other type of texture to ensure easy gripping of the handle. In another embodiment, the handle contains no recesses such that the user is not limited to placement of his fingers on certain locations of the handle. The handle may be constructed of a soft, slip resistant material such as a soft silicone.

FIG. 2 illustrates a close up view of one embodiment of the handle 2. Similar in overall shape to the handle 2 in the knife 1 in FIG. 1, this handle 2 includes a groove 9 extending downwards at an angle from the top of the handle 2. Preferably, a matching groove extends down the opposite side (not shown). The groove 9 or grooves functions to improve the control and comfort of the handle and additionally provide a finger guard.

The blade can be constructed of any material conventionally used to make knife blades but preferably a high grade stainless steel. Similarly, the handle can be constructed of a variety of materials typically used to make knife handles, such as a molded plastic material Preferably, the handle is of unitary construction, such as cured resin, so that the portion that extends over the blade is integral with the rest of the handle, however, this is not a requirement. In an alternate embodiment, one portion of the handle can cover the tang of the blade while another portion cover the bolster, heel and spine of the blade. The tang 10, shown in dotted lines, is preferably made of the same material as the knife blade, but may also be constructed of a different material.

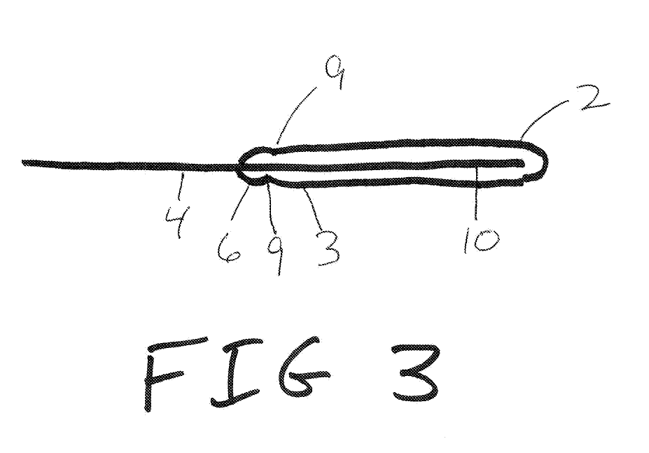

In one especially preferred embodiment, the handle is constructed from a soft silicone, which silicone handle is slightly softer than the usual silicone handle. This provides more comfort for the user but still maintains durability. The silicone can be any color but in one embodiment it is clear. FIG. 3 illustrates a top view of the clear silicon handle constructed in accordance with the invention.

The knife may be made of one solid piece which includes a blade portion, a bolster portion and a tang portion, where the tang portion, bolster portion and part of the blade portion are covered by the soft slip resistant material. The slip resistant material may be manufactured as one piece or several pieces, and is preferably made by injection molding. The soft slip resistant material may also comprise one or more of a variety of plastic materials, such as polyethylene, polypropylene, polycarbonate, ABS, acrylic, rubber, and nylon.

As can be seen in FIG. 3 the handle 2 cover the tang 10 and extends beyond where the bolster 3 would be along the spine 4. Optional grooves 9 can be seen on either side of the portion 6 of covering the heel 7. In one preferred embodiment, the tang extends throughout the entire length of the handle as is shown in FIG. 3. The handle may constructed of one piece which is fastened to the tang using a compression fit and one or more pins or threaded fasteners which are preferably secured from one side of the handle through the tang and out to the other side of the handle. Various adhesives may be employed in conjunction with or instead of these fasteners. The handle of the present invention is designed such that the heel covering portion 13 and spine covering portion 14 fit flush with the heel and the spine of the knife, respectively. This ensures that the handle and the portions which cover parts of the blade do not slip or move during use.

There will be various modifications, adjustments, and applications of the disclosed invention that will be apparent to those of skill in the art, and the present application is intended to cover such embodiments. Accordingly, while the present invention has been described in the context of certain preferred embodiments, it is intended that the full scope of these exceed these preferred embodiments.

1. A knife comprising:
a blade; and
a handle attached to the blade, wherein the handle extends horizontally down the spine towards the tip and vertically down the heel to cover a portion of the blade.

2. The knife of claim 1 wherein the knife does not have a bolster.

3. The knife of claim 1 wherein the knife has a bolster and the handle covers the bolster.

4. The knife of claim 1 wherein the entire handle is of unitary construction.

5. The knife of claim 4 wherein the handle is constructed of a soft silicone.

6. A knife, comprising:
i) a blade member having a bottom edge for cutting a surface and a top edge on the opposite side of the bottom edge, the two edges extending longitudinally from a heel portion of the blade member at the proximal end of the knife and meeting at a point at the distal end of the knife, wherein the blade member has a first side and a second side,
ii) a tang member integrally connected to and extending longitudinally from the heel portion of the blade member,
iii) an elongate handle member which is secured to the tang member and covers the entire tang member, a portion of the top edge of the blade member and at least a part of the heel portion of the blade member, the handle member being constructed of a soft resilient material.

7. The knife of claim 6, wherein the handle member extends transversely from a point on the top edge of the blade member to a point along the heel portion of the blade member such that a portion of the first side and second side of the blade member are covered.

8. The knife of claim 7, wherein the handle member is secured to the tang member using one or more fasteners.

9. The knife of claim 8, wherein the soft resilient material of the handle member comprises one or more of silicone, rubber, polyethylene, polypropylene, polycarbonate, ABS, acrylic and nylon.

10. The knife of claim 1, wherein the handle member is a single piece and is compression fitted around at least the tang member.

11. The knife of claim 1, wherein the tang member and the blade member are made of a single piece.

12. The knife of claim 11, wherein the tang member and blade member are constructed of stainless steel.

13. The knife of claim 1, further comprising one or more indentations on the handle member configured to receive the index finger or thumb.

14. The knife of claim 13, further comprising one or more grooves on the handle member to aid in grasping the handle member.

15. A method of controlling a knife, the method comprising:
i) grasping the knife of claim 1 with one hand by placing an index finger on the first side of the knife and a thumb on the second side of the knife while wrapping the remaining three fingers around the elongate handle member such that the palm of the hand rests on the handle member,
ii) applying a downward force on the knife with the hand such that a portion of the hand which rests on the handle member is pushed down against the top edge of the blade member, and
iii) applying a sideways force on the knife with the hand such that a portion of the hand which rests on the handle member is pushed against the heel of the blade member.
